(19) United States
(12) Patent Application Publication
(10) Pub. No.: US 2008/0272103 A1
(43) Pub. Date: Nov. 6, 2008

(54) Heated handle construction

(76) Inventor: Robyn J. Farrington, Westfield, NJ (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 11/983,117

(22) Filed: Nov. 7, 2007

Related U.S. Application Data
(63) Continuation-in-part of application No. 11/839,859, filed on Aug. 16, 2007.
Application No. 11/839,859 is a continuation-in-part of application No. 11/800,390, filed on May 4, 2007.

(51) Int. Cl. H05B 3/00; A45B 25/00; A45B 3/00; H05B 3/06; B25G 1/00; H05B 1/00

(52) U.S. Cl. 219/201; 135/16; 135/66; 15/105; 219/204; 294/54.5

(57) ABSTRACT

A heated handle construction for integration within an umbrella, cane, walker, crutches, wheelchair, snow shovel, baby stroller, golf club, hockey stick, animal lead/leash, knitting needle and crochet hook is provided having an integral stem portion constructed with a handle portion, a central shaft, and a bearing member. The handle has an outer show surface and is composed of a thermally insulating material, wound with wrapped flexible heating tape or strip, and connected through an on-off switch to a plurality of batteries present in a hollow cavity of the central shaft. Optionally, a thermally insulating foam tape is inserted between the heating element and the thermally insulating handle. An infrared reflector placed below the heating element directs heat to the user's hand. The heating element raises the temperature of the handle, radiating heat to the hand of the user, thereby providing a comfortable grip during use in wintry weather.

### RELATED U.S. APPLICATION DATA

This application is a continuation-in-part of co-pending U.S. patent application Ser. No. 11/839,859, filed Aug. 17, 2007, which, in turn is a continuation-in-part of co-pending U.S. patent application Ser. No. 11/800,390, filed May 4, 2007, the entire disclosures of which are incorporated by reference herein as if being set forth in their entirety.

### BACKGROUND OF THE INVENTION

1. Field of the Invention

The present invention relates to hand warming apparatus associated with handles of implements and devices appointed for low-temperature use; and more particularly, to a device having a stem including a central shaft housing batteries in communication with heating elements associated with a handle and/or arm rest that is constructed from a thermally insulating material, and has an outer show layer to warm the handle or arm rest appointed to be held, gripped or in otherwise contact with hands or arms of a user. The hand warming apparatus has particular application for use in the construction of umbrellas, canes, walkers, walking sticks, crutches, wheelchairs, snow shovels, baby carriages, strollers, golf clubs, hockey sticks, animal leads, pet leashes, and knitting needles and crochet hooks.

2. Description of the Prior Art

The handles and/arm rests of umbrellas, canes, walkers, walking sticks, crutches, wheelchairs, snow shovels, baby carriages, strollers, golf clubs, hockey sticks, animal leads, pet leashes, and knitting needles and crochet hooks are generally the first element contacted when the device is placed in service. Oftentimes, and particularly during the winter months, these handles become cold and uncomfortable to touch, or to grip for an appreciable period of time. Many patents address issues related to warming handles of various devices, such as fishing rods, ski poles, motorcycle handles, and the like. These patents do not address warming the handles of umbrellas, canes, walkers, walking sticks, crutches, wheelchairs, snow shovels, baby carriages, strollers, golf clubs, hockey sticks, animal leads, pet leashes, and knitting needles and crochet hooks using self-contained electrical power accessed through a user-operated switch.

Various devices have been provided that disclose heated fishing rods.

U.S. Pat. No. 744,789 to Fliess discloses a heated fishing rod including a handle heated by electrical wires powered by an external battery; however the polished porcelain surface of the fishing rod handle is not a metal, and does not reflect infrared radiation. Moreover, power is supplied from batteries, which are not contained within the fishing rod or its handle.

U.S. Pat. No. 3,164,921 to Mavrakis discloses a heated fishing rod wherein fishing line guides are heated by battery power to prevent ice freezing over the fishing line. A plurality of rods through which the fishing line is passed is heated by battery power. Though the heated rods pass through the handle, the thick insulation of the handle substantially prevents any of the heat from reaching the hand of the user.

U.S. Pat. No. 4,598,192 to Garrett discloses an electrically heated handle for a fishing rod and teaches a conductive aluminum shell contacting the hand of the fisherman with an insulating Steatite body is inserted within the aluminum thermally conductive shell. A heating coil, powered by an external battery, is wound in a pair of passages on the outer surface of the insulating Steatite body. The coil first heats the insulating Steatite body, which is a poor conductor. Heat and thermal contact between the aluminum shell and the insulating Steatite body raises the temperature of the aluminum shell handle. Due to the insulating character of the Steatite body, the handle stays warm for a long time, even when the heating coil is switched off. Since the heating coil is in very close proximity with the aluminum shell, the coil has a tendency to become short circuited thereby. Due to the poor heat conduction character of the Steatite body, the heating coil may overheat and burn out. At any rate, the heating of the insulating body is very slow, with the result that heat delivery to the hand is not robust. The fishing rod handle disclosed by the '192 patent would not be suitable for umbrellas, canes, walkers, walking sticks, crutches, wheelchairs, snow shovels, baby carriages, strollers, golf clubs, hockey sticks, animal leads, pet leashes, and knitting needles and crochet hooks. Moreover, the battery for heating the heating coil is external and is not contained within the handle.

U.S. Pat. No. 5,517,786 to Peissig discloses a heated fishing rod having of a foam handle, plastic cylinder, plastic coated heat tape, rechargeable battery pack, on/off toggle button, electronic regulator, reel holder, metal housed ceramic eyes, and tapered rod shaft. Within the foam handle is a plastic cylinder that houses the battery pack and fixtures for electrical contacts. The rechargeable batteries in the handle heat the fishing rod at the handle and at the ceramic eyelets, providing heat to the hand and to the ceramic eyelets for easy movement of the fishing line, when turned on by a switch. The heat is provided by a plastic coated heating tape that is wrapped in the required locations. The process by which the electrical circuit heats the wrapped tape is unclear. The device disclosed by the '786 patent is a heated fishing rod. No disclosure is contained there in concerning heated handles for umbrellas, canes, walkers, walking sticks, crutches, wheelchairs, snow shovels, baby carriages, strollers, golf clubs, hockey sticks, animal leads, pet leashes, and knitting needles and crochet hooks.

Other heated devices disclosed by prior art workers include heated umbrellas; but these umbrella devices are not equipped with heated handles. U.S. Pat. No. 1,683,270 to Taylor et al. discloses a radiation receiving conductor via an umbrella having a wound coil receiving electromagnetic radio waves. U.S. Pat. No. 2,496,501 to Staunton et al. discloses an umbrella wherein the cover of the umbrella has a novel, inexpensive, folding structure. U.S. Pat. No. 2,757,679 to Rivkin et al. discloses an emergency umbrella having a small number of parts and a water repellant canopy. These heated umbrella devices do not suggest use of a heated handle for umbrellas, canes, walkers, walking sticks, crutches, wheelchairs, snow shovels, baby carriages, strollers, golf clubs, hockey sticks, animal leads, pet leashes, and knitting needles and/or crochet hooks.

Additionally, U.S. Pat. No. 3,739,792 to Holland discloses an umbrella with heat generating means. Electric heating elements located in ribs of the umbrella framework heat the volume of air present under the umbrella canopy. Electrical heaters in the vertical column are powered by a plurality of batteries contained within the vertical column or carried elsewhere in a pocket or briefcase. The heating elements in the vertical column heat the surrounding air, which rises upwards. The heaters do not therefore warm the handle of the umbrella at the local where the user's hands make contact therewith, and does not provide a heated handle for umbrellas, canes, walkers, walking sticks, crutches, wheelchairs, snow shovels, baby carriages, strollers, golf clubs, hockey sticks, animal leads, pet leashes, and knitting needles and/or crochet hooks.

U.S. Pat. No. 4,978,110 to Lin et al. discloses a fire protection umbrella having an asbestos cloth covered with a flame retardant paint, and with ceramic tiles or hollow tubes. An umbrella cover is connected to strong umbrella ribs fashioned to function as a parachute. The handle of the fire retardant umbrella is not heated.

U.S. Pat. No. 5,625,960 to Fujita discloses a unit for removing rainwater from umbrellas including an umbrella insertion portion into which an umbrella that is wet with rain is inserted via a plurality of brushes and forced air circulation. This disclosure does not contemplate an umbrella having a heated handle, let alone means for heating handles of umbrellas, canes, walkers, walking sticks, crutches, wheelchairs, snow shovels, baby carriages, strollers, golf clubs, hockey sticks, animal leads, pet leashes, and knitting needles and/or crochet hooks.

U.S. Pat. No. 5,823,212 to Allen discloses a stadium umbrella having a cover composed of a transparent, as opposed to an opaque, material. Coverage is provided for the torso of the user. The umbrella comprises a transparent cover through which the user can see a sports event. A motor driving a wiper for the umbrella is powered by batteries contained in the umbrella's handle or shaft. The handle of the umbrella is not heated. Batteries in the umbrella shaft drive the wiper motor; but do not supply power to a handle heater. A heated handle integrated into umbrellas, canes, walkers, walking sticks, crutches, wheelchairs, snow shovels, baby carriages, strollers, golf clubs, hockey sticks, animal leads, pet leashes, and knitting needles and/or crochet hooks is not disclosed.

U.S. Pat. No. 7,003,217 to Bachinski et al. discloses an infrared heating system for patio umbrellas wherein a plurality of infrared heaters are mounted on the cross support members, and additionally on the support stand, provide infrared heat to the users under the umbrella. The handle of the umbrella is not heated, and the reference does not provide heated handles for umbrellas, canes, walkers, walking sticks, crutches, wheelchairs, snow shovels, baby carriages, strollers, golf clubs, hockey sticks, animal leads, pet leashes, and knitting needles and/or crochet hooks.

Foreign Patent Publication No EP1504689 to Bowyer et al. discloses an umbrella adapted to incorporate a heater attached to the ribs of the umbrella and heats the users within the canopy of the umbrella, however the handle of the umbrella is not provided with a heater and this disclosure does not disclose a heated handle in umbrellas, canes, walkers, walking sticks, crutches, wheelchairs, snow shovels, baby carriages, strollers, golf clubs, hockey sticks, animal leads, pet leashes, and knitting needles and/or crochet hooks.

Foreign Patent Publication No JP4067802 to Naonori discloses an umbrella handle containing a heating element that releases heat during oxidation. An airtight bag contains the product subject to oxidation. An air hole is opened to allow oxidation to occur and thus cause heat production. This bag, containing an oxidizable product, forms a separate element and is therefore not integral with the umbrella. The handle of the umbrella is not heated by electrical wires or strip, and a heated handle for umbrellas, canes, walkers, walking sticks, crutches, wheelchairs, snow shovels, baby carriages, strollers, golf clubs, hockey sticks, animal leads, pet leashes, and knitting needles and/or crochet hooks.

Further heated devices provided deal with heated hand grips for motorcycles, golf clubs and other apparatuses. These heated hand grips do not provide a heated handle integrated within a umbrellas, canes, walkers, walking sticks, crutches, wheelchairs, snow shovels, baby carriages, strollers, golf clubs, hockey sticks, animal leads, pet leashes, and knitting needles and/or crochet hooks.

U.S. Pat. No. 5,834,734 to Ogata discloses a handgrip with built-in heater. A cylindrical rubber handgrip body is connected to a handle bar pipe of, for example, a motor cycle. The rubber handgrip is slid over the handlebar of the motorcycle. A heating element is embedded in the rubber handgrip and is powered by an external battery, which constitutes the battery in the motorcycle. The handgrip with the built in heater is not integral to the motorcycle handle; but is instead slid-on over the handlebar. The '734 patented device is not used to heat the handles of umbrellas, canes, walkers, walking sticks, crutches, wheelchairs, snow shovels, baby carriages, strollers, golf clubs, hockey sticks, animal leads, pet leashes, and knitting needles and/or crochet hooks. Other similar motorcycle slip-on handle heaters are disclosed by U.S. Pat. Nos. 5,735,037, 5,626,780 and 5,613,407.

U.S. Pat. No. 6,998,576 to Marquis discloses an electrically heated hand grip that is suited for handles of sports apparatus such as a golf club. An electrically heated hand grip, primarily for golf clubs, is slipped over the golf club so that the inner sleeve member bonds and is attached to the golf club by an adhesive. This requires the inner sleeve member to be straight and the golf club to have a straight cylindrical character. Such a device is not useful for handles of canes, walkers, walking sticks, snow shovels, baby carriages and strollers, which generally have a curved configuration. The heated hand grip is a separate device that is slipped onto a golf club by being inserted over a golf club handle and bonded thereto by adhesive. The heated hand grip does not provide a heated handle integrated within a umbrellas, canes, walkers, walking sticks, crutches, wheelchairs, snow shovels, baby carriages, strollers, golf clubs, hockey sticks, animal leads, pet leashes, and knitting needles and/or crochet hooks.

U.S. Pat. No. 7,119,304 to Meyers discloses a heated handgrip. This rechargeable, reusable heated hand grip is designed for use on a ski pole, shovel or other cold weather hand-held tool or object. This heated hand grip constitutes a separate assembly with batteries, a switch and a heating element that surrounds a central core and is placed within an outer casing. The heated handgrip is attached to a ski pole by use of a bushing that is attached to the top of the ski pole by setscrews. The heated hand grip is slid on the bushing, securing it to the ski pole. This sliding action requires that the ski pole, or other device to which the heated handgrip is attached, be straight; not curved. On the other hand, handles of umbrellas, canes, walkers, walking sticks, crutches, wheelchairs, snow shovels, baby carriages, strollers, golf clubs, hockey sticks, animal leads, pet leashes, and knitting needles and/or crochet hooks, are generally not straight; but are, instead, have curved segments. Consequently, a hand grip heater of the type disclosed by the '304 patent, cannot be slid-on and secured to the curvilinear handles. The heated hand grip disclosed by the '304 patent is a removable, separate device; and is therefore not an integral part of a device.

Additional heated devices disclosed by prior art workers utilize portable heaters and various ceramic heaters. These heated devices do not suggest a heated handle integrated within a cane, walker, walking stick, baby carriage and stroller, and/or snow shovel.

U.S. Pat. No. 4,210,073 to Weiss discloses a portable environmental chamber. This environmental chamber is in the form of a dome that covers food and has an internal electrical heater that keeps the food warm. The '073 patent does not disclose or suggest a umbrellas, canes, walkers, walking sticks, crutches, wheelchairs, snow shovels, baby carriages, strollers, golf clubs, hockey sticks, animal leads, pet leashes, and knitting needles and/or crochet hooks having a heated handle integrated therein.

Foreign Patent Publication No JP6203947 to Tsumoru discloses a ceramic heater. This ceramic heater is a carbon based heater wherein conductive carbon powder is perfectly or partially covered over an insulating ceramic inner part. Such a structure forms a general purpose ceramic heater. The '947 patent does not disclose a heater in the handle of a umbrellas, canes, walkers, walking sticks, crutches, wheelchairs, snow shovels, baby carriages, strollers, golf clubs, hockey sticks, animal leads, pet leashes, and knitting needles and/or crochet hooks.

There remains a need in the art for a heated handle integrated within umbrellas, canes, walkers, walking sticks, crutches, wheelchairs, snow shovels, baby carriages, strollers, golf clubs, hockey sticks, animal leads, pet leashes, and knitting needles and/or crochet hooks. Also needed are umbrellas, canes, walkers, walking sticks, crutches, wheelchairs, snow shovels, baby carriages, strollers, golf clubs, hockey sticks, animal leads, pet leashes, and knitting needles and/or crochet hooks having integrated therein a heated handle and/or arm rest that can readily be switched on by the user to prevent hand contact with a cold handle thereof; and which will maintain a warm temperature on the user's hand during use in cold weather.

### SUMMARY OF THE INVENTION

The present invention provides a heated handle construction that is integral with a umbrellas, canes, walkers, walking sticks, crutches, wheelchairs, snow shovels, baby carriages, strollers, golf clubs, hockey sticks, animal leads, pet leashes, and knitting needles and/or crochet hooks. The heated handle utilized in these particular devices can readily be switched on in advance of use to prevent hand contact with a cold handle before a warmer handle temperature is achieved. Warmth is maintained on the user's hands and arms (where applicable, as with a wheelchair) while the user is walking in low-temperature environments, such as those encountered during fall and winter. Moreover, the warming effect on the user's hands provides comfort and relieves pain otherwise encountered by individuals with arthritic hands and joints.

Broadly stated, the heated handle construction includes an integral stem portion having a distal end and a proximal end. The integral stem portion comprises a handle located on the proximal end, a central shaft, and a bearing member located on the distal end. The central shaft is appointed for retaining a plurality of batteries therein for powering heating elements associated with the handle portion. The handle portion is constructed from a thermally insulating material and has an outer layer, which is the show layer or contact interface for the user's hand. The handle portion is wrapped with the integral heating elements to adjust the handle to a comfortable temperature level. The batteries housed within the central shaft are connected in series and power the heating element through an on-off switch so that the handle is warmed efficiently to a temperature level that provides a comfortable grip for the user. The heated handle construction has particular application for use in the assembly of umbrellas, canes, walkers, walking sticks, crutches, wheelchairs, snow shovels, baby carriages, strollers, golf clubs, hockey sticks, animal leads, pet leashes, and knitting needles and crochet hooks. As a result, the umbrella, cane, walker, walking stick, crutches, wheelchair, snow shovel, baby carriage, stroller, golf club, hockey stick, animal lead, pet leash, and knitting needle and/or crochet hook provides a heated handle that is warm to the touch even during use at low temperatures when walking or working in wintry or drafty weather.

Further provided is an umbrella having a heated handle construction. The umbrella includes an integral stem portion and a canopy portion. The integral stem portion comprises a handle, a central shaft, a spring member and a plurality of extension rods. The central shaft retains a plurality of batteries. The handle portion is constructed from a thermally insulating material and an outer layer. The thermally insulating material is wrapped with integral heating elements powered by batteries, connected in series, through an on-off switch. The canopy has an external surface and an internal surface. The external surface of the canopy is water repellent and thereby resists saturation and sheds or facilitates the repellency of rain drops. The water repellent canopy prevents accumulation of water on the outer layer of the handle portion and the handle is warmed efficiently, to thereby raise the handle temperature to a level that provides a comfortable grip for the user.

### BRIEF DESCRIPTION OF DRAWINGS

The invention will be more fully understood and further advantages will become apparent when reference is had to the following detailed description and the accompanying drawings, in which:

FIG. 1 is a cross-sectional side view of a walking stick or cane with the heated handle construction integrated therein, illustrating the details of the heater arrangement in the handle and showing the outer layer covering of the handle and optional external covering of the stem shaft;

FIG. 1.1 illustrates the details of an insulating ceramic, wood or polymeric material of a handle wrapped with heating elements;

FIG. 1.2 illustrates placement of an insulating foam material between the insulating handle and the wrapped heating elements;

FIG. 1.3 illustrates placement of an infrared reflective foil or membrane between the heating element and the insulating foam material;

FIG. 1.4 illustrates an on-off switch with selectable heat delivery control;

FIG. 2 illustrates a side view of a walker with the heated handle construction integrated therein;

FIG. 3 illustrates a front view of a snow shovel with the heated handle construction integrated therein;

FIG. 4 illustrates a view of a stroller with the heated handle construction integrated therein;

FIG. 5a is a schematic side view a side view of the Umbrella with Heated Handle and Water Repellant Canopy Fabric;

FIG. 5b illustrates the heater arrangement in the handle of the umbrella;

FIG. 6 illustrates a side view of a wheelchair with the heated handle construction integrated therein along with heated arm rests;

FIG. 7 illustrates a view of a pair of crutches with the heated handle construction integrated therein along with heated arm rests;

FIG. 8a illustrates a view of a golf club with the heated handle construction integrated therein;

FIG. 8b illustrates a view of a hockey stick with the heated handle construction integrated therein;

FIG. 9 illustrates a view of a pet leash with the heated handle construction integrated therein; and

FIG. 10 illustrates a view of a knitting needle and/or crochet hook with the heated handle construction integrated therein.

### DESCRIPTION OF THE PREFERRED EMBODIMENTS

This invention relates to a heated handle construction for integration into umbrellas, canes, walkers, walking sticks, crutches, wheelchairs, snow shovels, baby carriages, strollers, golf clubs, hockey sticks, animal leads, pet leashes, and knitting needles and crochet hooks. Briefly stated, the heated handle construction warms a user's hands while walking or working in frigid or cool temperatures. In the absence of the present invention, the handle temperature of such devices tends to reach the ambient temperature. Consequently, the handle becomes uncomfortable to grasp, especially in cold environments. In accordance with the present invention, the handle having a heated construction is provided with a heating element that raises the temperature of the handle surface to substantially the temperature of the hand, allowing the user to grip the handle with minimal discomfort. A warming effect on the user's hands is thereby produced, aiding comfort and relieving pain for individuals with arthritic hands.

Typically, the handle of the umbrella, cane, walker, walking stick, crutches, wheelchair, snow shovel, baby carriage, stroller, golf club, hockey stick, animal lead, pet leash, knitting needle and/or crochet hook is made having an outer show layer and an inner insulating body such as a ceramic, wood or polymeric molded material. Due to the insulating character of the heated handle construction, its heating rate and cooling rate are very small. That is to say, the heated handle construction takes a long time to heat or cool. In a preferred embodiment, the heated handle construction is first wrapped with an insulating polymeric foam material, which is highly flexible and provides a soft cushiony feel to the handle. The plastic material in itself is highly insulating and the presence of closed cells of entrapped air provides additional insulation. This flexible foam is wrapped with a heating tape. The heating tape comprises a plurality of 25 micrometer diameter wires wound or laid in a zig zag pattern, and entrapped in a polymeric adhesive sheet. Such heating tapes are available from MINCO, and are described in detail at http://www.minco.com/uploadedFiles/Products/Thermofoil_Heaters/aa30-transparent_htrs.pdf. Alternatively, the heating tape may be a thin sheet of Grafoil, which has a resistivity, typically in the range of 1 to 8×10-4 ohm-inches that is approximately 5 to 25 times as that of a metal. Such Grafoil heating tapes are marketed by Q-foil, and are described in detail at http://www.egc-ent.com/html/qfoil.html. These thin flexible graphite foils are embedded in a plastic layer that may be adhesively coated. This thin polymeric coating on thermofoil heaters or Q-foil heaters protects the internal components of the handle while, at the same time, facilitating delivery of generated heat to the hand of the user. Owing to the insulating character of the handle and the use of insulating flexible polymeric foam, the heat generated is not lost or dissipated within the mass of the handle. The insulating foam cushions the handle, providing a comfortable grip without subjecting the wrapped heating elements to a sharp curvature. A sharp curvature typically has a small curvature radius and can potentially fracture a 25 micrometer heating wire or crack thin sheets of graphite foil. In the case of thermofoil heaters, which use 25 micrometer wires, a reflective metallic sheet or membrane may be inserted between the thermofoil element and the flexible polymeric foam to direct the infrared radiation from the heater to the hand of the user. The membrane may be a sheet of metal or a metallized polymeric sheet.

The heating element is connected through a user operated switch to a set of batteries connected in series. The batteries are contained in the stem of the heated handle of the cane, walker, stroller and/or snow shovel. Preferably, the batteries are rechargeable and deliver a combined voltage of 12 volts. With this voltage, the batteries can be easily charged using a charger connected to a house voltage outlet or directly charged by the cigarette lighter of a car or a van. In a preferred embodiment, the user operated switch may have two positions. One of the switch positions can be used to drain the rechargeable battery that supplies power to the heating elements, or to use the cigarette lighter connection. In an alternate embodiment, the switch may include multiple positions delivering 50% or 100% of the heating current to the heating elements.

The outer layer of the handle portion is provided as the show surface and contact surface for the user's hand. The outer layer is preferably water proof, coated by a wax, silicone or Teflon (polytetrafluroethylene) material, to resist accumulation and penetration of water on the handle portion and visa vie the heating elements. The outer layer of the handle portion may be composed of the following materials: a polymeric material; a natural material, selected from a group consisting of wood, leather, shearling, suede, fur, or reptile skins; a fabric material, selected from a group consisting of wool, cashmere, blended knits, lycra, nylon, cotton or denim; a foam or rubber product; a metal; a ceramic material; or a tourmaline material.

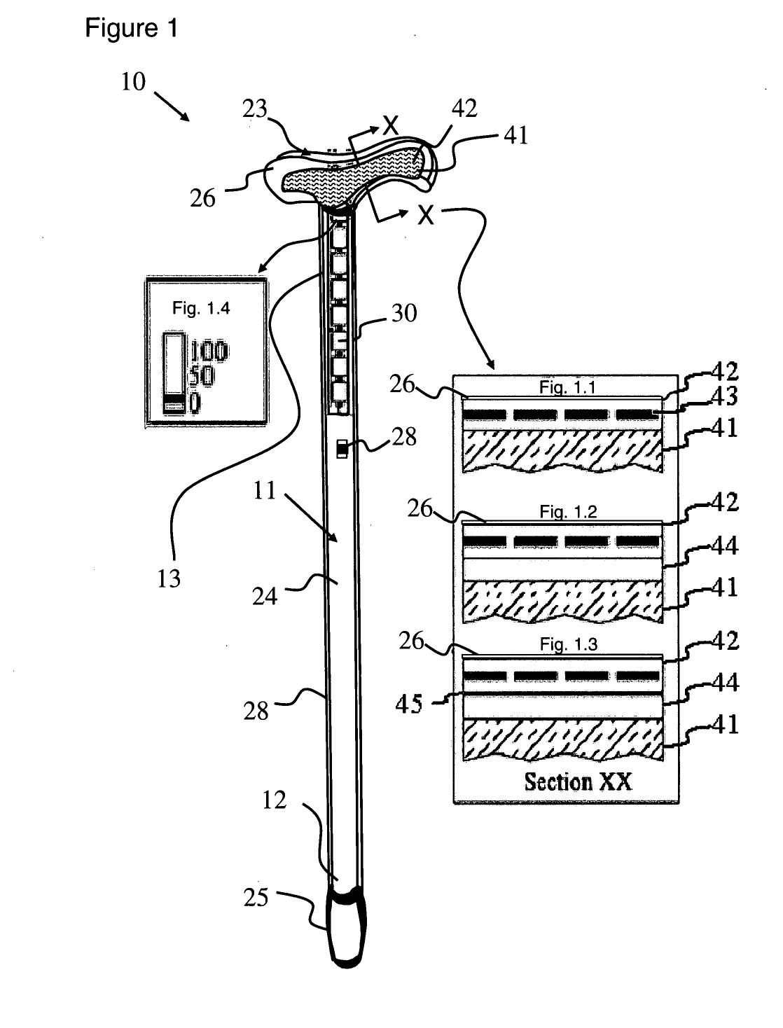

FIG. 1 illustrates generally at 10 a cross-sectional side view of a walking stick or cane with the heated handle construction integrated therein. The walking stick 10 includes an integral stem portion 11 having a distal end 12 and a proximal end 13. Stem portion 11 further includes a handle 23 located on proximal end 13, a central shaft 24, and a bearing member 25 located on distal end 12. Herein, bearing member 25 is a support pad or cushion as is typically utilized at the end of canes, walking sticks, walkers, and the like. Handle portion 23 is constructed having an outer layer 26 and includes a thermally insulating material core 41 with integral heating elements 42 wrapped there around.

An on/off switch is shown at 28. Power means 30 comprises a plurality of batteries incorporated in the central shaft 24. The batteries/power means 30 are connected in series and power heating element 42 through the on-off switch 28 located on the cane, walker, walking stick 10, snow shovel, or baby carriage. As switch 28 is turned to the on position, handle 23 is warmed efficiently to raise handle 23 to a warm temperature level. As a result the cane/walking stick 10, stroller, or shovel provides a heated handle 23 that is warm to the touch even during use at low temperatures outside when walking in wintry weather. Outer layer 27 is composed of a thin layer (ranging from 0.1 inch-1 inch in thickness) of material. This material may be a polymeric material or blend thereof, a foam or rubber product. Alternatively, the outer layer 26 of handle portion 23 may be composed of a natural material, selected from a group consisting of wood, leather, shearling, suede, fur, or reptile skins for comfort and aesthetic purposes. Optionally, the outer layer 26 of handle portion 23 may be composed of a fabric material, selected from a group consisting of wool, cashmere, blended knits, lycra, nylon, cotton or denim. The outer layer 26 may be a ceramic material or tourmaline material.

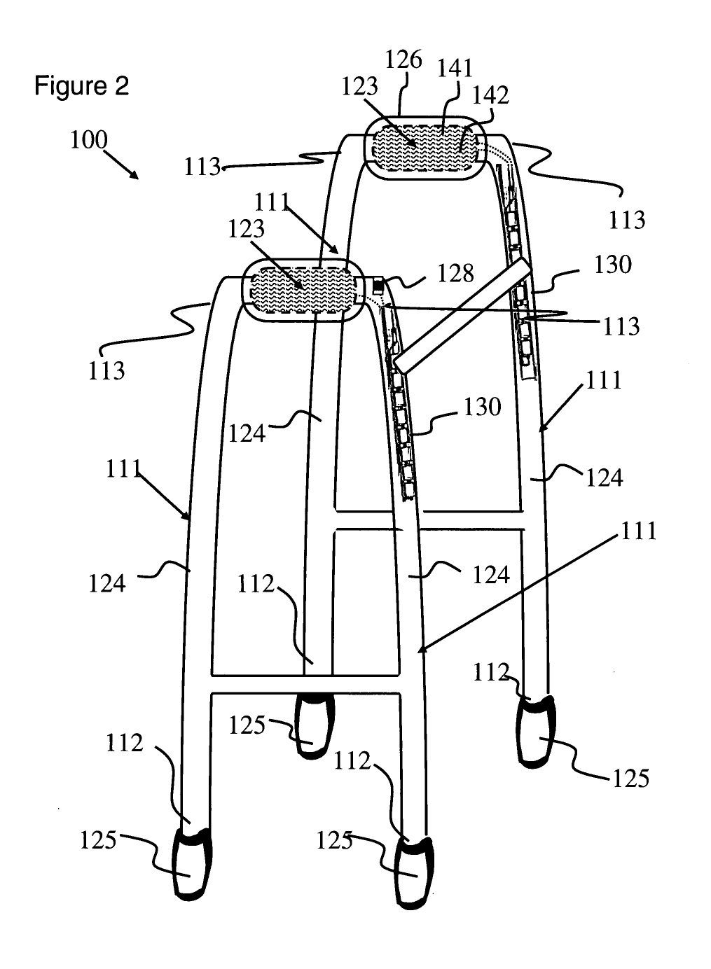

FIGS. 1.1-1.4 illustrate the details of the heated handle construction as utilized in walking stick 10 (as well as the stroller, walker, and shovel discussed hereinafter). Particularly: FIG. 1.1 illustrates the details of an insulating ceramic, wood or polymeric material of a handle wrapped with heating elements; FIG. 1.2 illustrates placement of an insulating foam material between the insulating handle and the wrapped heating elements; FIG. 1.3 illustrates placement of an infrared reflective foil or membrane between the heating element and the insulating foam material; and FIG. 1.4 illustrates an on-off switch with selectable heat delivery control. The heated handle is constructed from a thermally insulating material wrapped with integral heating elements to adjust the handle to a desired temperature level. Handle 23 (123, 223, and 323, 423, 523, 623, 682, 692, 704 and 754 via FIGS. 2, 3, 4, 5a & 5b, 6, 7, 8a & 8b, 9 and 10, respectively) has a central core made from an insulating ceramic, wood or polymeric material 41 and outer layer 26. In the first embodiment of the invention shown in FIG. 1.1, the heating element 42 is wrapped on the ceramic or polymeric insulating core and outer layer 26 covers heating element 42 and the core. The heating element comprises a set of metallic fine wires or Grafoil heaters 43 present in the encapsulated polymer of the heater. The second embodiment of the invention is shown in FIG. 1.2 wherein a flexible foam of polymeric material 44 which has air cells providing insulation is inserted between the ceramic or polymeric core 41 and the wrapped heating element 42. In the third embodiment of the invention, an infrared reflective metallic element 45 is inserted between the heating element 42 and the flexible foam of polymeric material 44. This infrared reflective metallic element 45 reflects the heat emitted by the heater 42 towards the hand of the user and reduces its leakage into the ceramic or polymeric core 41. Outer layer 26 does not interfere with heat transfer to the user's hand as outer layer 26 is generally thin in nature, having a thickness ranging from 0.1 inch to 1 inch thick. While the placement of the infrared reflective element shown in FIG. 1.3 is between the heating element and the flexible insulating foam material, it should be understood that the infrared reflective element may alternatively be placed between the heating element and the insulating handle without the use of flexible insulating foam. The stem portion of the cane, shovel, or stroller houses the power source which is shown to be series connected eight 1.5 volt cell adapted to produce a voltage of 12 volts. The series connected batteries power the heating elements through an on/off switch 28, the details of which are shown in FIG. 1.4. The switch, in addition to on and off positions, has a low heat intensity level at 50% value, as shown. A socket 46 is provided for connecting to the cigarette lighter connection in a car or SUV, enabling charging of rechargeable batteries 30 or the use of cigarette lighter power to drive the heating elements 42.

A variety of shaped or sized heated handle constructions can be utilized, such as “J” curved handles such as in the shape of the traditional cane, a straight handle, a finger-grooved handle, a semi U-shaped bar such as in the shape of a baby stroller handles, and the like. Optionally, the outer layer of the heated handle construction may be substantially water proof and thereby resist accumulation and penetration of water on the handle portion and the heating element. In particular, the outer layer may be coated with a material selected from a group consisting of wax, silicone or Teflon (polytetrafluroethylene). A heightened handle temperature radiates heat into the hands of the user, providing relief to those suffering from arthritis and carpal tunnel syndrome

FIG. 2 illustrates a side view of a walker with the heated handle construction integrated therein. An integral stem portion is constructed as an inverted U-shape having parallel legs to form a walker device, shown generally at 100. The heated handle construction is shown in FIGS. 1.1-1.4 discussed hereinabove. Walker 100 includes an integral stem portion 111 having a distal end 112 and a proximal end 113. Stem portion 111 further includes a handle 123 located on proximal end 113, a central shaft 124, and a bearing member 125 located on distal end 112. Bearing member 125 is a support pad or cushion as is typically utilized at the end of canes, walking sticks, walkers, and the like. Handle portion 123 is constructed having an outer layer 126 and includes a thermally insulating material core 141 with integral heating elements 142 wrapped there around. An on/off switch is shown at 128 for actuating power means 130 comprising a plurality of batteries incorporated in the central shaft 124 connected in series and power a heating element through the on-off switch 128 located on the walker's legs. Dual power means 130 are provided, as shown; alternatively there may be a single power means 130 located in one of the legs or in proximity to the handles 123.

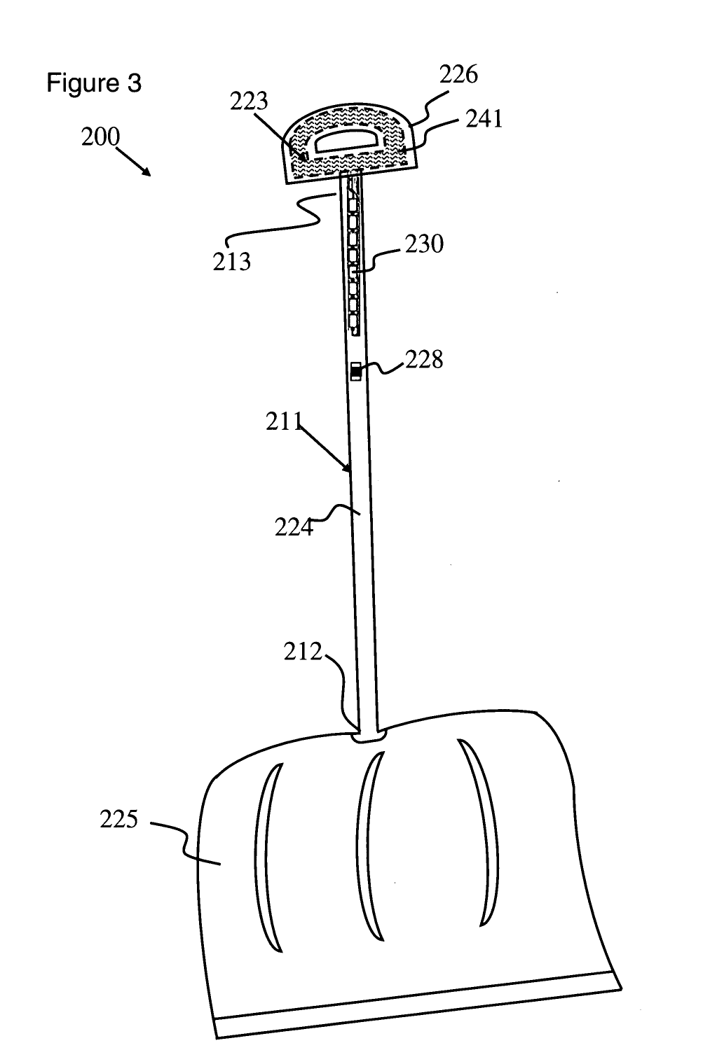

FIG. 3 illustrates a front view of a snow shovel with the heated handle construction integrated therein, shown generally at 200. The heated handle construction is shown in FIGS. 1.1-1.4 discussed hereinabove. Shovel 200 includes an integral stem portion 211 having a distal end 212 with a bearing member 125, herein shown as a shovel blade. A proximal end 213 is provided with a handle 223. A central shaft 224 includes an on/off switch is shown at 228 for actuating power means 230 comprising a plurality of batteries incorporated in the central shaft 224 connected in series and power a heating element through the on-off switch 228. Handle portion 223 is constructed having an outer layer 226 and includes a thermally insulating material core 241 with integral heating elements wrapped there around.

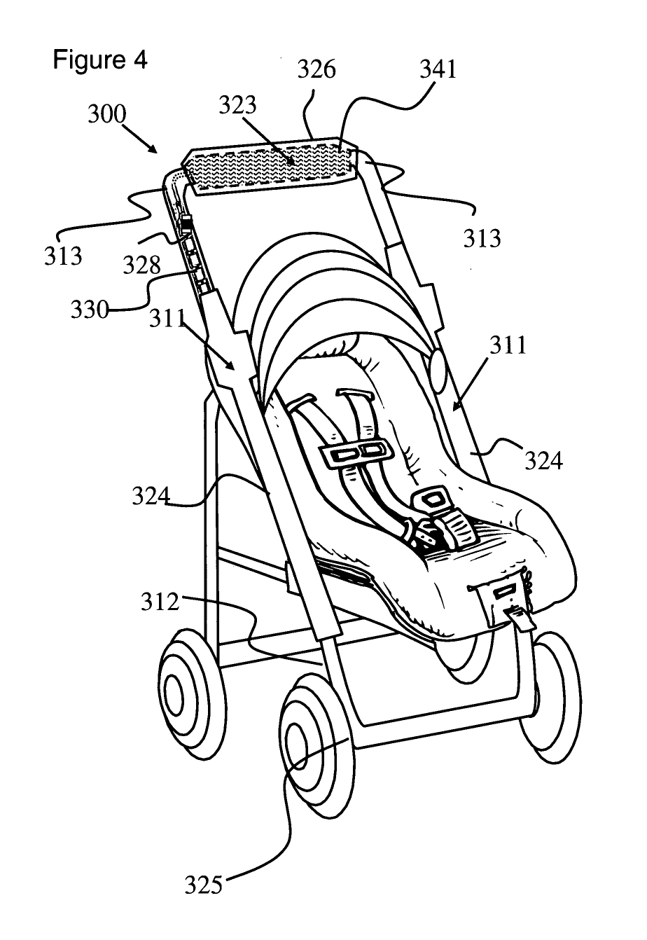

FIG. 4 illustrates a view of a stroller with the heated handle construction integrated therein, shown generally at 300. The heated handle construction is shown in FIGS. 1.1-1.4 discussed hereinabove. Baby Carriage 300 includes dual integral stem portions 311 having a distal end 312 with a bearing member 325, herein attached to wheels. Each of the proximal ends 313 converge to provide a handle 323 having an outer layer 326 and a thermally insulating material core 341 wrapped with integral heating elements. Alternatively, the proximal ends 314 may not converge, as with some strollers, and therefore each handle includes the ability to be heated via as described herein. A central shaft 324 includes an on/off switch 328, which is shown on one of the integral stem portions 311, for actuating power means 330. Power means 330 comprises a plurality of batteries incorporated in the central shaft 324 of one of the integral stem portions 311 (optionally, both stem portions may include the power means) connected in series and power a heating element through the on-off switch 328 and leading to each handle 323 on each of the integral stem portions 311.

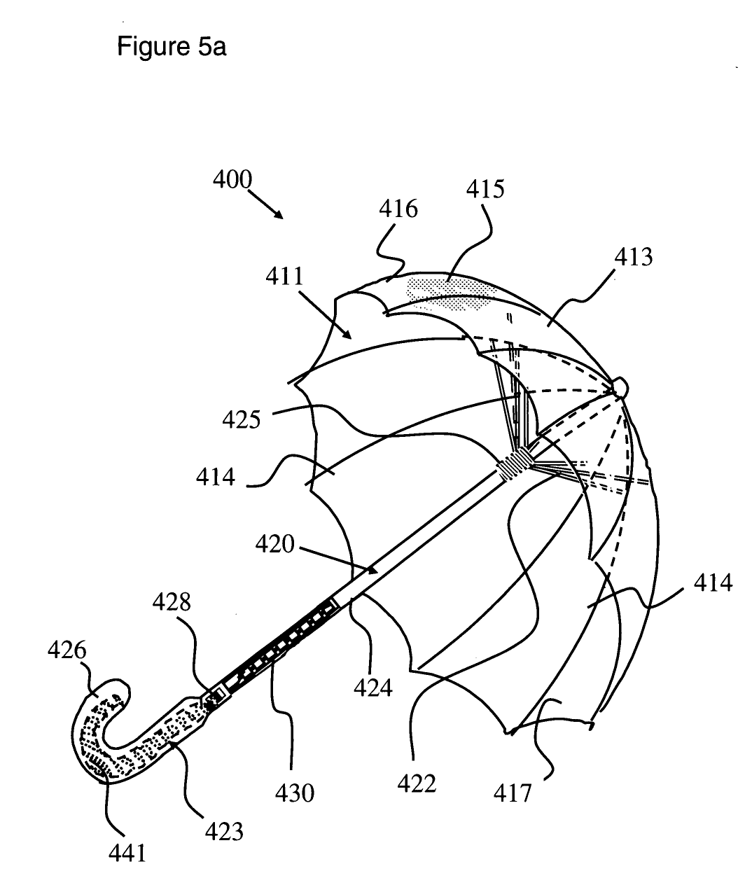

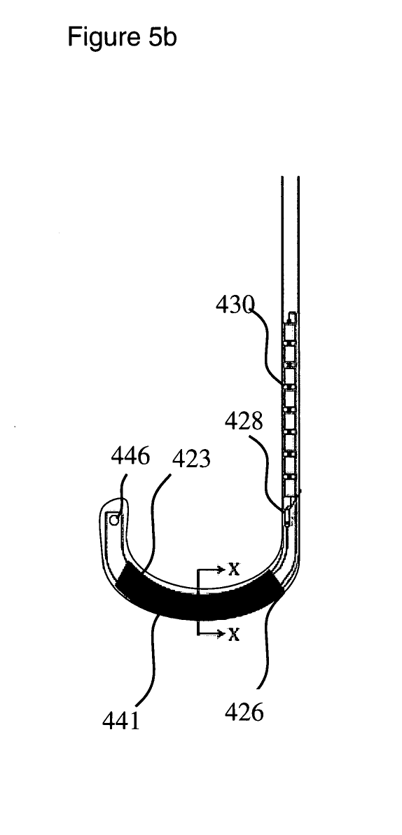

FIGS. 5a and 5b illustrate the heated handle construction integrated in an umbrella, shown generally at 400. The umbrella includes a stem portion 420 and a canopy portion 411. Stem portion 420 further includes a handle 423, a central shaft 424, a spring member 425, and extension rods 422. Handle portion 423 is constructed having an outer layer 426 and includes a thermally insulating material core 441 with integral heating elements wrapped there around. Canopy 411 has branches 414 extending therethrough. Branches 414 are attached to extension rods 422 so that the branches 414 expand when the extension rods 422 are extended to form an open state of the umbrella. Conversely, when extension rods 422 are contracted or folded, branches 414 retract to form a closed state of the umbrella, such as when it is being stored away after or between uses. Canopy 411 is constructed of a fabric having an exterior surface 416 and an interior surface 417. Exterior surface 416 of canopy 411 is water repellant, having a wax, Teflon or silicone coating, a portion of which is shown herein at 415. An on/off switch is shown at 428. Power means 430 comprises a plurality of batteries incorporated in the central shaft 424. A spring is shown at 425. Handle 423 has a central core 441 made from an insulating ceramic, wood or polymeric material, and an outer layer 426. As a result of using an umbrella with a handle heater and a water repellant canopy, the user can transition from a rainy environment to a dry environment without accumulation of water droplets on the umbrella handle. The repellency feature of the canopy prevents saturation thereof with water droplets, and drives water in a direction away from the umbrella handle. A heightened handle temperature radiates heat into the hands of the user, providing relief to those suffering from arthritis and carpal tunnel syndrome.

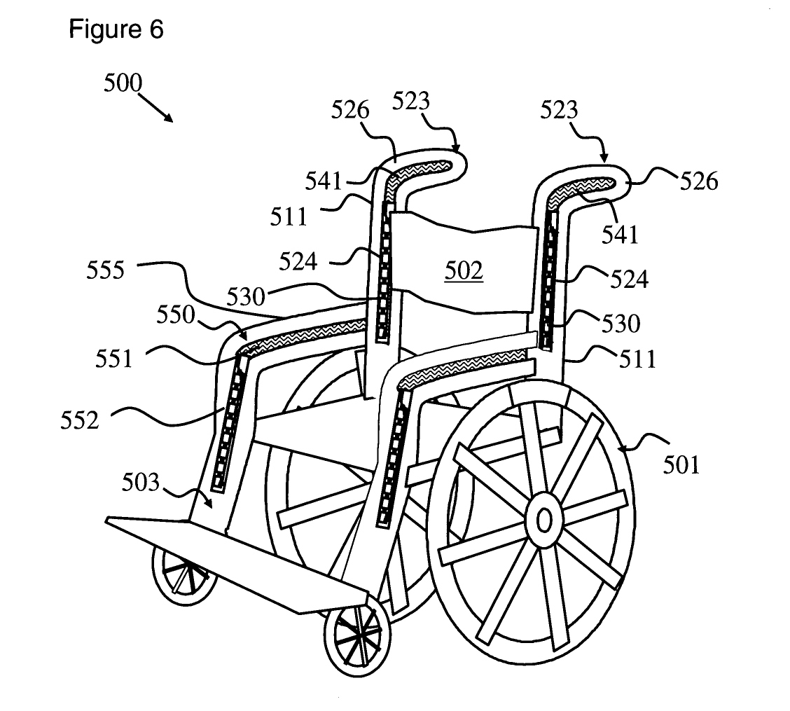

FIG. 6 illustrates a view of a wheelchair with the heated handle construction integrated therein along with heated arm rests, shown generally at 500. The heated handle construction is shown in FIGS. 1.1-1.4 discussed hereinabove. Wheelchair 500 includes wheels 501, chair 502 and frame 503. Frame 503 includes dual integral stem portions 511. Each of the proximal ends of stem portions 511 converge to provide a handle 523 having an outer layer 526 and a thermally insulating material core 541 wrapped with integral heating elements. A central shaft 524 includes an on/off switch for actuating power means 530, comprising a plurality of batteries incorporated in the central shaft 524 of one of the integral stem portions 511. In this embodiment, wheelchair 500 further includes heated arm rests 550 comprising an inner thermally insulating material bar 551 wrapped with integral heating elements and an outer cushioned layer 555. Batteries/power means are located in housing trunk 552 and are connected in series to communicate with the heating elements wrapped around inner thermally insulating material bar 551 through an arm rest on-off switch to provide a comfortable temperature to the user's arms.

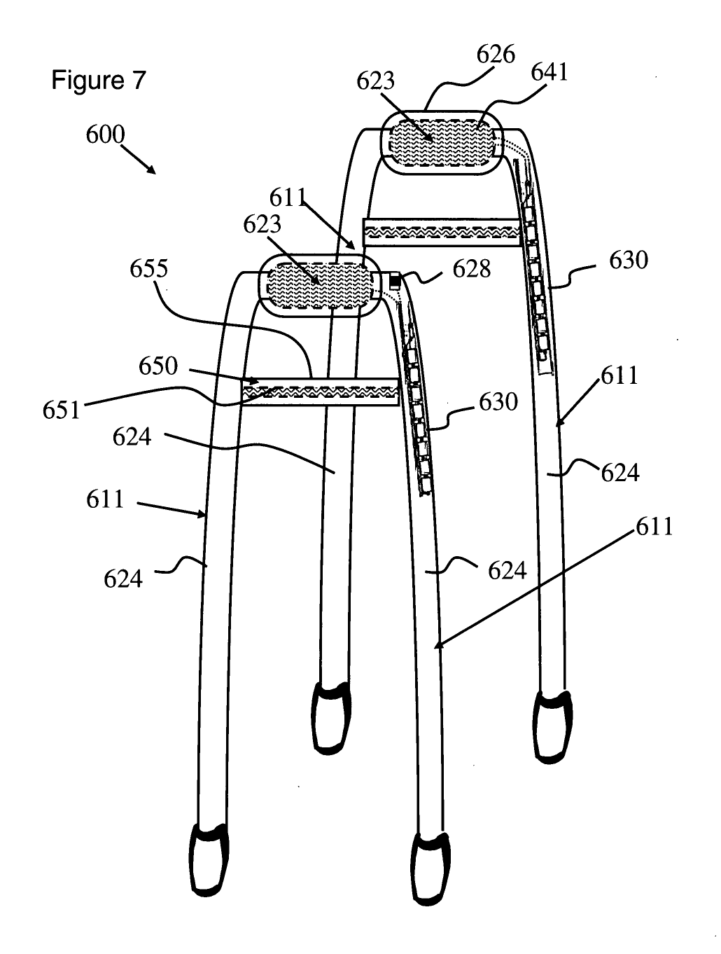

FIG. 7 illustrates a view of a pair of crutches with the heated handle construction integrated therein along with heated arm rests, shown generally at 600. The heated handle construction is shown in FIGS. 1.1-1.4 discussed hereinabove. Crutches 600 include dual integral u-shaped stem portions 611 having a handle 623 with an outer layer 626 and a thermally insulating material core 641 wrapped with integral heating elements. A central shaft 624 includes an on/off switch 628 for actuating power means 630, comprising a plurality of batteries. In this embodiment, crutches 600 further include heated arm rests 650 comprising an inner thermally insulating material bar 651 wrapped with integral heating elements and an outer cushioned layer 655, herein also powered by power means 630, but can be provided with their own respective battery power means.

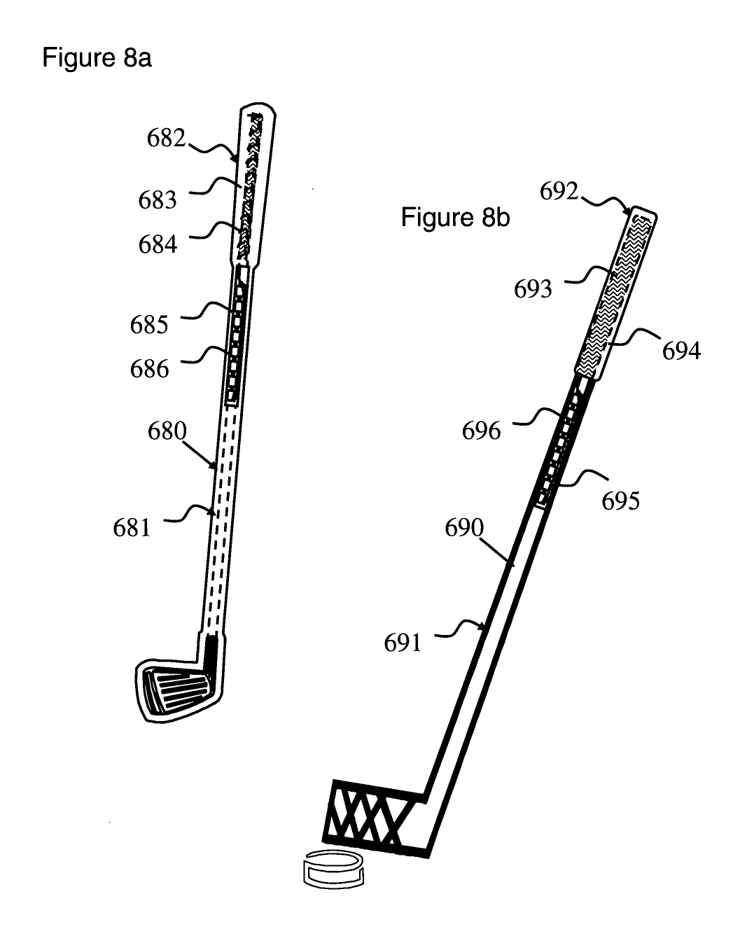

FIG. 8a illustrates a view of a golf club with the heated handle construction integrated therein. Club 680 includes integral stem 681 with heated handle portion 682 comprising an outer layer 683 and a thermally insulating material core 684 wrapped with integral heating elements activated via current supplied by power means 686, batteries, housed in central shaft 685 actuated by an on/off switch. FIG. 8b illustrates a view of a hockey stick 690 having an integral stem 691 with heated handle portion 692 comprising an outer layer 693 and a thermally insulating material core 694 wrapped with integral heating elements activated via current supplied by power means 696, batteries, housed in central shaft 695 actuated by an on/off switch.

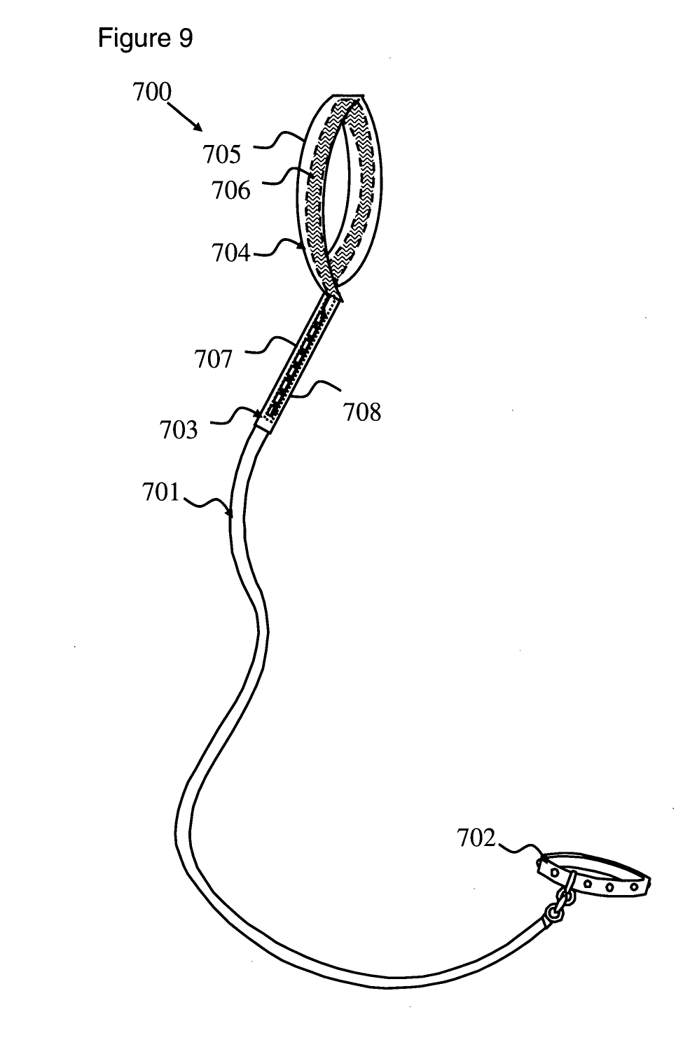

FIG. 9 illustrates a view of a pet leash with the heated handle construction integrated therein, shown generally at 700. Pet leash 700 includes a typical fibrous body portion 701 appointed to connect to a collar 702 for placement around an animal's neck. On the proximal end of body portion 701 of leash 700 there is a hardened integral stem 703, preferably comprised of a light weight durable plastic tube shaped portion. Integral stem 703 includes a heated handle portion 704, which is preferably constructed with a fibrous outer layer 705 and a flexible thermally insulating material core 706 wrapped with integral heating elements (discussed infra via FIGS. 1.1-1.4) activated via current supplied by power means 707, batteries, housed in a central shaft 708 located in integral stem 703 and actuated by an on/off switch. A harness may be provided, wherein the harness handle includes the heated handle configuration.

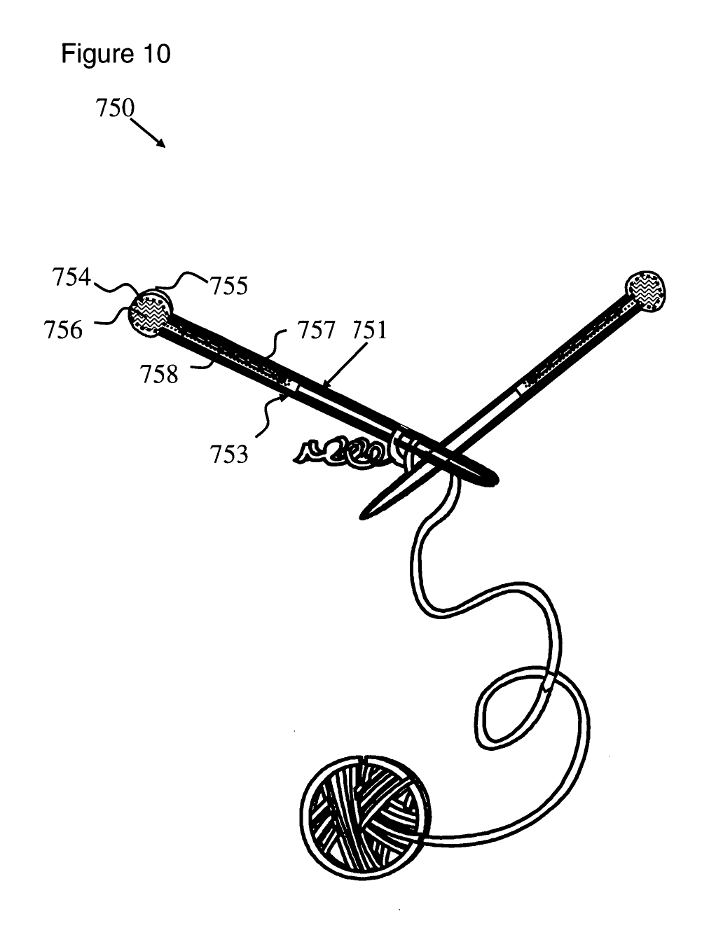

FIG. 10 illustrates a view of a knitting needle and/or crochet hook with the heated handle construction discussed in FIGS. 1.1-1.4 hereinabove, shown generally at 750. Knitting needle 751 includes an integral stem 753 with a heated handle portion 754 having an outer layer 755 substantially surrounding a flexible thermally insulating material core 756 wrapped with integral heating elements activated via current supplied by power means 758, batteries, housed in a central shaft 757 located in integral stem 753 and actuated by an on/off switch.

The heated handle construction for integration into umbrellas, canes, walkers, walking sticks, crutches, wheelchairs, snow shovels, baby carriages, strollers, golf clubs, hockey sticks, animal leads, pet leashes, and knitting needles and crochet hooks of the present invention comprises, in combination, the following salient features:
i) an integral stem portion having a distal end and a proximal end;
ii) the integral stem portion comprising a handle located on the proximal end, a central shaft, and a bearing member located on the distal end;
iii) the central shaft being appointed for retaining a plurality of batteries, preferably rechargeable batteries;
iv) the handle portion being constructed from a thermally insulating material core and an external outer layer;
v) the handle portion being wrapped with integral heating elements to adjust said handle to a temperature level;
vi) the batteries being connected in series and powering said heating element through an on-off switch;
vii) optionally, the handle's outer layer is substantially water proof and thereby resisting accumulation and penetration of water on the handle portion and the heating element;
viii) the core of the handle portion being constructed from an insulating polymeric, wood or ceramic material that is wrapped with integral heating elements;
ix) the heating elements comprising flexible tape or flexible strip;
x) optionally a foam of flexible tape being disposed between the insulating polymeric, wood or ceramic material and said heating elements, limiting heat transmission to the insulating polymeric, wood or ceramic material;
xi) optionally an infrared reflective metallic strip being placed under the heating element to direct infrared heat from heating elements to the hand of the user;
xii) the batteries being connected in series and powering the heating element through an on-off switch that is optionally provided with a heating intensity control;
xiii) optionally the batteries providing 12 volts, thereby matching voltage available in a cigarette lighter terminal of a car or SUV that is appointed for charging the rechargeable batteries;

While the integrated heated handle is disclosed with respect to a handle of umbrellas, canes, walkers, walking sticks, crutches, wheelchairs, snow shovels, baby carriages, strollers, golf clubs, hockey sticks, animal leads, pet leashes, and knitting needles and crochet hooks, the same heated handle configuration may be used for heating integral handles of other appliances, and tools, such as ice scrapers, snow blowers, ski poles, and the like.

Having thus described the invention in rather full detail, it will be understood that such detail need not be strictly adhered to, but that additional changes and modifications may suggest themselves to one skilled in the art. For example, the distal end of the cane or walker could have the shape of a palm grip, which may optionally be constructed for left-handed or right-handed use. Depending upon the size of the heated handle construction, there may be a need for two distal ends and/or two proximal ends which, if present, may require an additional heat source. A double baby stroller represents an example where, owing to the additional width of the handle, the stroller may profitably utilize a heated handle construction having two proximal ends and/or two distal ends. For handle constructions such as the pet leash shown in FIG. 9, power means 707 can, alternatively, be housed within the handle itself. Such modifications are intended to fall within the scope of the invention as defined by the subjoined claims.

What is claimed is:

1. A heated handle construction, comprising:
a. an integral stem portion having a distal end and a proximal end, said integral stem portion comprising a handle located on said proximal end, a central shaft, and a bearing member located on said distal end;
b. said central shaft being appointed for retaining a plurality of batteries;
c. said handle portion being constructed from a thermally insulating material and having an outer layer;
d. said handle portion being wrapped with integral heating elements to adjust said handle to a temperature level;
e. said batteries being connected in series and powering said heating element through an on-off switch;
whereby said handle is warmed efficiently to raise said handle to a temperature level that provides a comfortable grip for the user.

2. A heated handle construction as recited by claim 1, wherein said thermally insulating material is selected from a group consisting of molded polymer, wood or ceramic.

3. A heated handle construction as recited by claim 1, wherein said central shaft has a hollow cavity and retains batteries within said cavity.

4. A heated handle construction as recited by claim 1, wherein said batteries are rechargeable.

5. A heated handle construction as recited by claim 1, wherein said integral heating element is a wound flexible tape.

6. A heated handle construction as recited by claim 5, wherein said wound flexible tape has zig zag pattern of 25 micrometer wire.

7. A heated handle construction as recited by claim 1, wherein said integral heating element is a wound flexible strip.

8. A heated handle construction as recited by claim 7, wherein said wound flexible strip is a graphite foil strip.

9. A heated handle construction as recited by claim 1, wherein an infrared reflective membrane or foil is inserted between said integral heating element and said insulating material of said handle.

10. A heated handle construction as recited by claim 9, wherein said infrared reflective membrane or foil is a metallic foil.

11. A heated handle construction as recited by claim 9, wherein said infrared reflective membrane or foil is a metallized polymeric sheet.

12. A heated handle construction as recited by claim 1, wherein a thermally insulating flexible foam tape is inserted between said thermally insulating material of said handle and said integral heating element to thereby provide a cushioned grip on said handle.

13. A heated handle construction as recited by claim 12, wherein an infrared reflective membrane or foil is inserted between said integral heating element and said thermally insulating flexible foam tape.

14. A heated handle construction as recited by claim 1, wherein said batteries have an open circuit voltage of 12 V and are chargeable from said cigarette lighter connection in a car or SUV.

15. A heated handle construction as recited by claim 1, wherein said on-off switch additionally comprises 50% and 100% power settings.

16. A heated handle construction as recited by claim 1, wherein said handle is a finger grooved handle.

17. A heated handle construction as recited by claim 1, wherein said handle is a “J” curved handle.

18. A heated handle construction as recited by claim 1, wherein said handle is a straight handle.

19. A heated handle construction as recited by claim 1, wherein said handle is a semi “U-shaped” bar.

20. A heated handle construction as recited by claim 1, wherein said integral stem portion is part of a walking aid, including a cane, walking stick and polio sticks.

21. A heated handle construction as recited by claim 1, wherein said integral stem portion is constructed as an inverted U-shape having parallel legs to form a walker device or crutches.

22. A heated handle construction as recited by claim 1, wherein said integral stem portion is part of a snow shovel or ice-scraper.

23. A heated handle construction as recited by claim 1, wherein said integral stem portion is connected to and integrated within a stroller, baby carriage, or baby pram.

24. A heated handle construction as recited by claim 1, wherein said integral stem portion is connected to and integrated within sport equipment, including golf clubs and hockey sticks.

25. A heated handle construction as recited by claim 1, wherein said integral stem portion is connected to and integrated within animal leads, leashes and harness handles.

26. A heated handle construction as recited by claim 1, wherein said integral stem portion is connected to and integrated within knitting needles and crochet hooks.

27. A heated handle construction as recited by claim 1, wherein said integral stem portion is connected to and integrated within handicap equipment, including wheelchairs and crutches.

28. A heated handle construction as recited by claim 27, wherein said handicap equipment further comprises heated arm rest construction comprising an inner thermally insulating material bar wrapped with integral heating elements and an outer cushioned layer, said heating elements are powered by batteries housed in proximity to said arm rest, wherein said batteries communicate with said heating elements through an arm rest on-off switch.

29. A heated handle construction as recited by claim 1, wherein said outer layer of said handle portion is water proof and thereby resists accumulation and penetration of water on said handle portion and said heating element.

30. A heated handle construction as recited by claim 1, wherein said outer layer of said handle portion is composed of a polymeric material or mixture thereof.

31. A heated handle construction as recited by claim 1, wherein said outer layer of said handle portion is composed of a natural material, selected from a group consisting of wood, leather, shearling, suede, fur, or reptile skins.

32. A heated handle construction as recited by claim 1, wherein said outer layer of said handle portion is composed of a fabric, selected from a group consisting of wool, cashmere, blended knits, lycra, nylon, cotton or denim.

33. A heated handle construction as recited by claim 1, wherein said outer layer of said handle portion is composed of a foam or rubber product.

34. A heated handle construction as recited by claim 1, wherein said outer layer of said handle portion is composed of a metal.

35. A heated handle construction as recited by claim 1, wherein said outer layer of said handle portion is composed of a ceramic material.

36. A heated handle construction as recited by claim 1, wherein said outer layer of said handle portion is composed of a tourmaline material.

37. An umbrella having a heated handle construction, comprising:
a. an integral stem portion and a canopy portion;
b. said integral stem portion comprising a handle, a central shaft, a spring member and a plurality of extension rods;
c. said central shaft retaining a plurality of batteries;
d. said handle portion being constructed from a thermally insulating material and an outer layer;
e. said handle portion being wrapped with integral heating elements;
f. said batteries being connected in series and powering said heating element through an on-off switch;
g. said canopy having an external surface and an internal surface;
h. said external surface of said canopy being water repellent and thereby resisting saturation and shedding or facilitating said repellency of rain drops;
whereby said water repellent canopy prevents accumulation of water on said handle portion and said handle is warmed efficiently, to thereby raise said handle temperature to a level that provides a comfortable grip for said user.

38. An umbrella as recited by claim 37, wherein said water repellant canopy external surface is coated with a material selected from a group consisting of wax, silicone or Teflon (polytetrafluroethylene).

39. An umbrella as recited by claim 37, wherein said outer layer of said handle portion is composed of a polymeric material.

40. An umbrella as recited by claim 37, wherein said outer layer of said handle portion is composed of a natural material, selected from a group consisting of wood, leather, shearling, suede, fur, or reptile skins.

41. An umbrella as recited by claim 37, wherein said outer layer of said handle portion is composed of a foam or rubber product.

42. An umbrella as recited by claim 37, wherein said outer layer of said handle portion is composed of a metal, ceramic or tourmaline material.
